(19) United States
(12) Patent Application Publication
(10) Pub. No.: US 2005/0175518 A1
(43) Pub. Date: Aug. 11, 2005

(54) Gas-processing apparatus

(76) Inventors: Jao-Ching Lin, Hsin Chuang (TW); Tien-Shun Ma, Hsin Chung (TW)

Correspondence Address: Ann Tsai;PMB 174, Suite 137, 931 West 75th Street, Naperville, IL, 60565, US

(21) Appl. No.: 10/773,048

(22) Filed: Feb. 6, 2004

(51) Int. Cl. B01J 19/08

(52) U.S. Cl. 422/186.3

(57) ABSTRACT

A gas-processing apparatus, comprising a casing that has an internal space and designed to connect to computers, portable electronic apparatuses, or IA devices, etc., an light source covered with an optical catalyst in said space, a fan unit adjacent to said light source; actually, said light source and fan unit are deployed in a gas flow path in said internal space; the ultraviolet radiation of the ultraviolet lamp and the optical catalyst under ultraviolet radiation of the ultraviolet lamp can eliminate odor, exhaust gas, toxic matter, or dust contained in the gas emitted from said computers, portable electronic apparatuses, or IA devices, and then the treated gas is expelled out by the fan unit.

### BACKGROUND OF THE INVENTION

1. Field of the Invention

The present invention relates to a gas-processing apparatus, particularly to a gas-processing apparatus that may be mounted on computers, portable electronic apparatuses, or IA devices and utilizes titanium dioxide optical catalyst to clean gas emitted from said computers, portable electronic apparatuses, or IA devices.

2. Brief Description of Related Art

With the development of technology, people not only invent innovative inventions to improve life level but also improve life convenience with high technologies. However, as those inventions appear, our environment is polluted severely, for example, though automobiles bring us unprecedented convenience, the exhaust gas (e.g., carbon monoxide and carbon dioxide) from automobiles causes severe pollution to the atmosphere. Similarly, industrial exhaust gas also results in severe environmental pollution and diseases of respiratory tract (e.g., asthma).

To solve severe atmospheric pollution issues, air purifier products are invented, for example, a air filter utilizes filtering film (or filtering screen) and active carbon to filter air, i.e., it utilizes sorption principle to filter floating particles, bacteria, and impurities in the air; however, such air purifier products only implement absorption function instead of sterilization or deodorization function. Furthermore, the filtering film or filtering screen has to be replaced periodically; otherwise it itself becomes a pollutant source when the absorbed matters are excessive, not to say attaining the designed air filtration object.

Some other air purifiers, such as electronic dust collectors, optical catalyst (ozone or ultraviolet) purifiers, in particular air purifiers that utilize strong deoxidization property of titanium dioxide to purify air, are favored by people. In such an air purifier, when the pollutant passes through said titanium dioxide optical catalyst, an ultraviolet lamp radiates ultraviolet radiation onto said titanium dioxide optical catalyst to activate oxygen and water molecules around said titanium dioxide optical catalyst into highly active free radicals, which can almost decompose any harmful or toxic organic matter or inorganic matter to attain sterilization and deodorization objects.

By now, though above optical catalyst air purifier products are widely used in air conditioning devices, fans, etc., they have not been used in computers, TVs, portable electronic devices, and IA devices, the electric crystal units of which, during their operation, will generate harmful or toxic gas. The harmful or toxic gas will flow out through ventilation holes on the equipment and cause harm to people. In addition, dust may deposit at the ventilation holes as time evolves and becomes another pollutant that endangering people.

### SUMMART OF THE INVENTION

The main object of the present invention is to provide a gas-processing apparatus that may be used in computers, portable electronic apparatuses, and IA devices and utilize ultraviolet radiation, titanium dioxide, and fan unit to attain sterilization and deodorization objects.

To attain said object, the present invention provides a gas-processing apparatus comprising at least a casing, an light source unit, and a fan unit; said casing has an air inlet and an air outlet; said light source unit is a ultraviolet lamp deployed in air flow path in the internal space of the casing and covered with a optical catalyst layer (titanium dioxide); said fan unit is adjacent to said light source. The radiation of said ultraviolet lamp and/or the optical catalyst in the internal space create redox and sterilization effect to eliminate odor, exhaust gas, toxic matter, or dust in the gas generated from the computers, portable electronic apparatuses, or IA devices, and then the fan unit expels the treated gas out of the casing.

Another object of the present invention is to attain heat-expelling effect with the fan unit for electric crystal in said computers, portable electronic apparatuses, or IA devices.

The structure, principle, and efficacy of the present invention are described in further detail according to the following embodiment with reference to the attached drawings.

### BRIEF DESCRIPTION OF THE DRAWINGS

FIG. 1 is an exploded perspective view of the present invention;

FIG. 2 is a perspective view of the present invention; and

FIG. 3 is a perspective view illustrating an embodiment of the present invention.

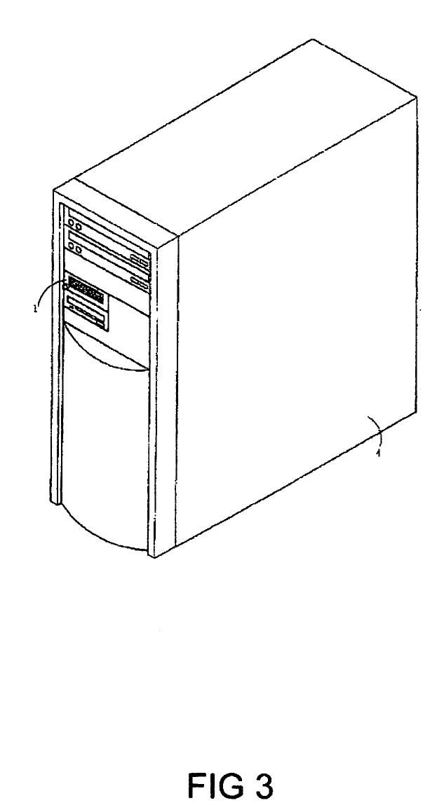

### DETAILED DESCRIPTION OF THE PREFERRED EMBODIMENT

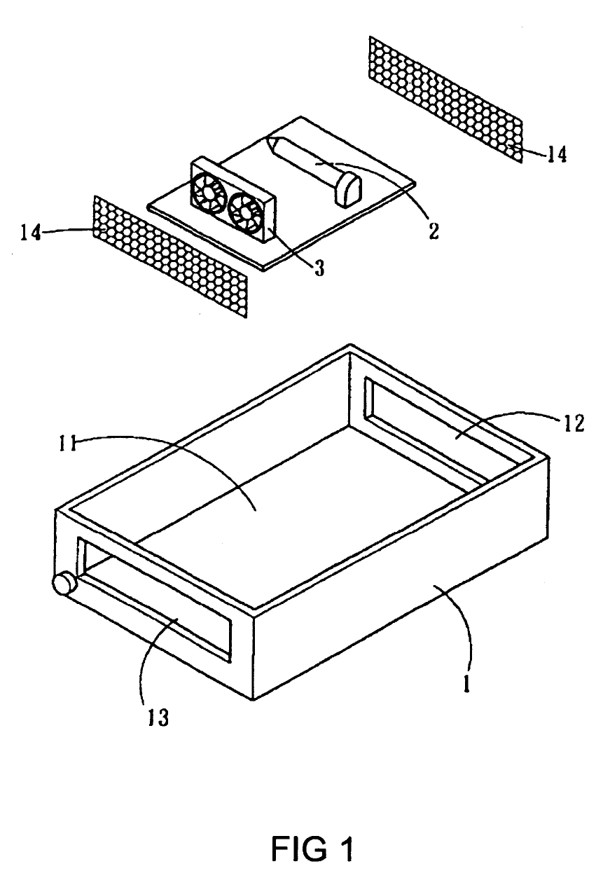

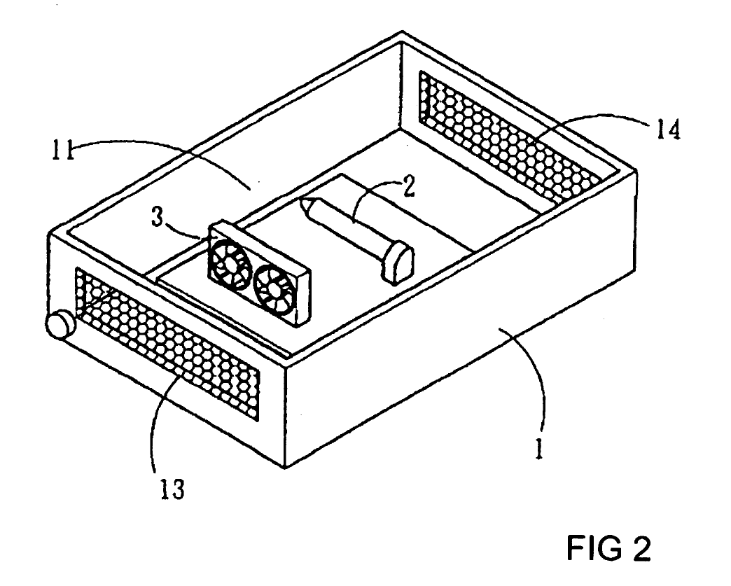

Referring to FIGS. 1 and 2, the gas-processing apparatus of the present invention may be used in computers, portable electronic apparatuses, or IA devices and mainly comprises a casing 1, an light source unit 2, and a fan unit 3; said casing encloses an internal space 11 and has an air inlet 12 and an air outlet 13, and at least a filtering unit 14 (e.g., filtering film/filtering screen, or active carbon) is mounted on said air inlet 12 or air outlet 13;
a light source unit 2, which is deployed in the air flow path in the internal space 11 in said casing 1 (in the present embodiment, it is deployed at the air inlet side) and may be a ultraviolet lamp that radiates ultraviolet radiation, which cause ambient air create photochemical action to generate ozone that provides sterilization and deodorization effect;
a fan unit 3, which is deployed at air inlet 12 or air outlet 13 in the internal space 11 of said casing 1 and adjacent to said light source 2, and is designed to expel treated gas outside of the casing 1.

In addition, the embodiment of the present invention has at least an optical catalyst layer (titanium dioxide) in the internal space of said casing or on the surface of said ultraviolet lamp; under the radiation of ultraviolet lamp, said optical catalyst layer creates redox and sterilization effect.

When the raw gas containing odor, exhaust gas, toxic matter, or dust pass through said casing 1, it is filtered by the filtering unit 14 at the air inlet 12 to get off floating particles and dust; then under the radiation of said ultraviolet lamp, oxygen in filtered gas creates photochemical action to generate ozone that provides sterilization and deodorization function to purify the gas primarily, and oxygen and water molecules around the optical catalyst (titanium dioxide) are activated into highly active free radicals, which can decompose any harmful or toxic organic matter or inorganic matter to attain secondary purification including sterilization, deodorization, and antifouling effects; finally, the treated gas is expelled outside of the casing by the fan unit.

In addition, the fan unit in the present invention can not only draw in and expel gas flow, but also provide heat-expelling function for electric crystal and other components in said computers, portable electronic apparatuses, or IA devices.

Furthermore, the light source unit (ultraviolet lamp) in the present invention may be a light-emitting diode (LED).

The gas-processing apparatus in the present invention may be designed as a module to use in any portable device or a removable stick form that is powered via a USB plug to expand its applicability.

While the invention has been described with referencing to a preferred embodiment thereof, it is to be understood that modifications or variations may be easily made without departing from the spirit of this invention, which is defined by the appended claims.

1. A gas-processing apparatus used in computers, portable electronic apparatuses, or IA devices, at least comprising a casing, a light source unit covered with an optical catalyst in said casing, and a fan unit adjacent to said light source; actually, said light source unit and fan unit being deployed in the air flow path in said casing; said ultraviolet lamp radiating ultraviolet radiation onto the optical catalyst to completely eliminate odor, exhaust gas, toxic matters, or dust contained in the gas generated from said computers, portable electronic apparatuses, or IA devices, and then the fan unit expelling the processed gas (fresh gas) outside of said casing.

2. A gas-processing apparatus used in computers, portable electronic apparatuses, or IA devices, at least comprising a casing with an optical catalyst layer inside, an light source unit mounted in said casing, and a fan unit adjacent to said light source unit; actually, said light source unit and fan unit being deployed in the air flow path in said casing; said ultraviolet lamp radiating ultraviolet radiation onto the optical catalyst layer inside of said casing to completely eliminate odor, exhaust gas, toxic matters, or dust contained in the gas generated from said computers, portable electronic apparatuses, or IA devices, and then the fan unit expelling the processed gas (fresh gas) outside of said casing.

3. A gas-processing apparatus according to claim 1, wherein said casing encloses an internal space and has an air inlet and an air outlet.

4. A gas-processing apparatus according to claim 2, wherein said casing encloses an internal space and has an air inlet and an air outlet.

5. A gas-processing apparatus according to claim 3, wherein at least a filtering unit is mounted at said air inlet or said air outlet.

6. A gas-processing apparatus according to claim 4, wherein said filtering unit is a filtering screen/film or active carbon;

7. A gas-processing apparatus according to claim 3, wherein said fan unit is deployed at least at said air inlet or at air outlet of the internal space of said casing and adjacent to said light source unit;

8. A gas-processing apparatus according to claim 1, wherein said gas-processing apparatus can be designed as a module that can be used in any portable apparatus or a portable stick form that is powered via a USB plug to expand its applicability.

9. A gas-processing apparatus according to claim 2, wherein said gas-processing apparatus can be designed as a module that can be used in any portable apparatus or a portable stick form that is powered via a USB plug to expand its applicability.
